(19) United States
(12) Patent Application Publication
(10) Pub. No.: US 2020/0299802 A1
(43) Pub. Date: Sep. 24, 2020

(54) RESISTANCE ANNEALING FURNACE TO ANNEAL AT LEAST ONE METAL OR METAL ALLOY WIRE, STRAND, STRING, WIRE ROD OR STRIP

(71) Applicant: SAMPSISTEMI S.R.L., Bentivoglio (IT)

(72) Inventors: Enrico Conte, Bentivoglio (IT); Salvatore de Chiara, Bentivoglio (IT); Gianpaolo Martucci, Bentivoglio (IT)

(21) Appl. No.: 16/088,631

(22) PCT Filed: Mar. 31, 2017
(86) PCT No.: PCT/IB2017/051858

§ 371 Date: Sep. 26, 2018

(30) Foreign Application Priority Data
Mar. 31, 2016 (IT) 102016000033186

(51) Int. Cl. C21D 9/62; C21D 1/26; C21D 1/42; F27B 9/14; F27D 11/04

(52) U.S. Cl. CPC C21D 9/62; C21D 1/26; C21D 2241/00; F27B 9/145; F27D 11/04; C21D 1/42

(57) ABSTRACT

Resistance annealing furnace to anneal at least one metal or metal alloy wire, strand, string, wire rod or strip, the annealing furnace having at least two electric axles provided with respective electric contact rings for conveying the metal or metal alloy wire, strand, string, wire rod or strip, and a DC voltage generator, which can be supplied by an AC voltage (Uac) to generate an annealing voltage (Uann) applied between the two electric axles so as to produce an electric current in the portion of the metal or metal alloy wire, strand, string, wire rod or strip extending between the two electric axles, which provokes an annealing due to the Joule effect. At least one of the electric contact rings is made of a non-metal electric conductor material, for example graphite.

### TECHNICAL FIELD

The present invention relates to a resistance annealing furnace to anneal at least one metal or metal alloy wire, strand, string, wire rod or strip.

In particular, the present invention finds advantageous, but not exclusive, application in in-line resistance annealing, i.e. directly at the outlet of a machine for the simultaneous production of one or more aluminium or aluminium alloy wires or wire rods, for example a wire-drawing machine, to which the following description will make explicit reference without thereby losing generality.

### PRIOR ART

A direct current resistance annealing furnace adapted to be arranged in line, i.e. downstream of a wire-drawing machine, normally comprises at least two, and in particular three electric axles, which are provided with respective electric contact rings and are motorised to drag the metal or metal alloy wire or plurality of wires if the wire-drawing machine is a multiwire machine, a plurality of idle or motorised transmission rollers and a motorised outlet pull ring. The transmission rollers and the outlet pull ring are arranged so as to define a given path for the wire, which starts around the contact ring of a first electric axle, turns around the contact rings of the other two electric axles and the transmission rollers, and ends around the outlet pull ring.

The annealing furnace comprises an electric apparatus for generating a direct current voltage which is applied between the second electric axle and the other two electric axles, i.e., for example, the positive potential of the electric voltage is applied to the second electric axle and the negative potential of the electric voltage is applied to both the first and the third electric axles. The annealing process occurs by Joule effect due to the passage of current in the wire portions between the second electric axle and the other two (first and third) electric axles.

The path of the wire is divided into a pre-heating portion that goes from the first electric contact ring to the second electric contact ring, a real annealing portion that goes from the second electric contact ring to the third electric contact ring, and a cooling portion that goes from the third electric contact ring to the outlet pull ring. The pre-heating portion has a length greater than that of the annealing portion so that the temperature gradient of the wire in the pre-heating portion is lower than that of the wire in the annealing portion.

The electric voltage applied between the electric axles and the corresponding electric current that circulates in the wire are commonly known as annealing voltage and annealing current, which in general depend on the length of the pre-heating and annealing portions, the feeding speed of the wire along the path, and the material and section of the wire.

The electric contact rings of the electric axles are made of a metallic material, for example steel, in order to allow the maximum conduction of electric current during their contact with the wire to be annealed. The metal of the wire to be annealed, i.e. aluminium or copper, or aluminium or copper alloys, tends to oxidise during the annealing and the metal difference between the electric contact rings and the wire tends to diffusionally migrate metallic material from the wire to the electric contact rings. This entails the deposition of metal debris on the electric contact rings, which worsens the electrical conduction between the wire and the electric contact rings and generally accelerates the surface wear of the electric contact rings.

The European patent EP1206583B1 describes an annealing furnace for annealing an aluminium or aluminium alloy wire, wherein the electric contact rings are made of aluminium or aluminium alloy in order to reduce the metal diffusion between the wire to be annealed and the electric contact rings. However, the solution proposed by patent EP1206583B1 has the drawback that the electric contact rings need to be changed whenever a different metal wire needs to be annealed. In other words, to anneal a wire of a given metal alloy, it is necessary to use electric contact rings made of the same metal alloy.

### OBJECT OF THE INVENTION

The object of the present invention is to provide a resistance annealing furnace to anneal an aluminium or aluminium alloy wire, which furnace is free from the drawbacks described above and, at the same time, is easy and inexpensive to manufacture.

In accordance with the present invention, a resistance annealing furnace is provided for the annealing of at least one metal or metal alloy wire, strand, string, wire rod or strip, as defined in the appended claims.

### BRIEF DESCRIPTION OF THE DRAWINGS

The present invention will now be described with reference to the accompanying drawings, which illustrate a non-limiting embodiment thereof, in which:

FIG. 1 schematically illustrates the direct current resistance annealing furnace manufactured according to the present invention; and

FIG. 2 illustrates the annealing furnace according to a further embodiment of the present invention.

### PREFERRED EMBODIMENT OF THE INVENTION

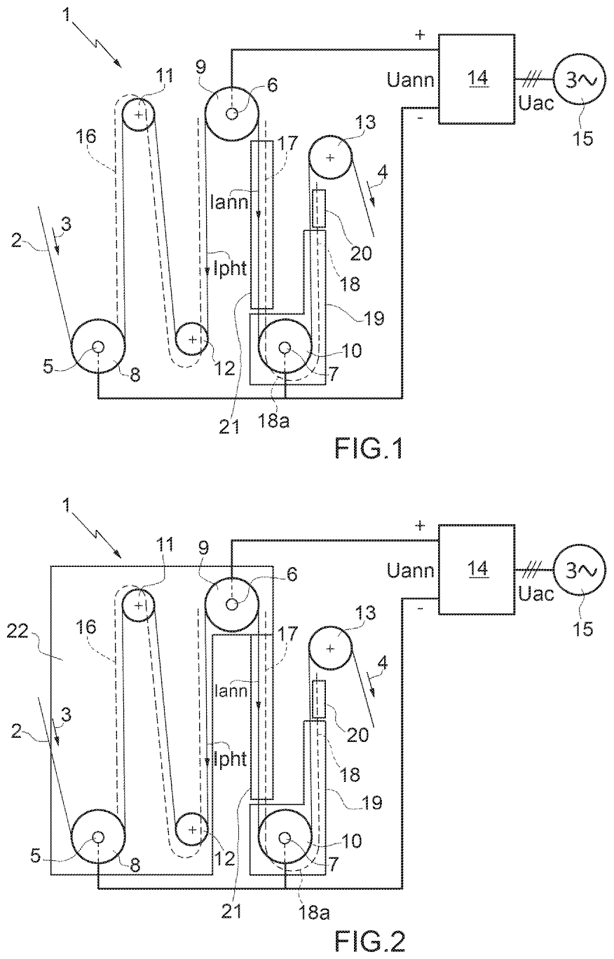

In FIG. 1, reference numeral 1 generally designates, as a whole, a direct current resistance annealing furnace for annealing a metal wire, the latter indicated by reference numeral 2, and in particular a wire made of aluminium or copper, or of an aluminium- or copper-based metal alloy. The annealing furnace 1 is of the type preferably, but not necessarily, adapted to work in line, i.e. arranged between the outlet of a wire-drawing machine, known per se and therefore not illustrated, and the inlet of a winding machine, also known per se and therefore not illustrated. The wire 2 exits the wire-drawing machine and enters the annealing furnace 1 moving forward in direction 3 and exits the annealing furnace 1 in direction 4.

With reference to FIG. 1, the annealing furnace 1 comprises three electric axles 5, 6 and 7, which are provided with respective electric contact rings 8, 9 and 10, at least two transmission rollers 11 and 12, which are either idle or motorised and are arranged between the first two electric axles 5 and 6, and a motorised outlet pull ring 13. The transmission rollers 11 and 12 and the outlet pull ring 13 are arranged so as to define a given path for the wire 2, which starts around the electric contact ring 8, turns around the transmission rollers 11 and 12 and the two electric contact rings 9 and 10, and ends around the outlet pull ring 13. The wire 2 runs along this path being dragged, i.e. pulled, by the outlet pull ring 13, substantially without sliding around the electric contact rings 8, 9 and 10 and the transmission rollers 11 and 12.

Advantageously, the electric contact rings 8, 9 and 10 are also motorised to aid the pulling of the wire 2.

The annealing furnace 1 comprises a DC voltage generator 14, which can be supplied by an AC voltage, and in particular by the three-phase Uac voltage supplied by a three-phase electric grid 15, to generate a DC voltage, the so-called annealing voltage, indicated by Uann in the figures, which is applied between the electric axle 6 and the other two electric axles 5 and 7. The annealing process occurs by Joule effect due to the passage of electric current in the wire portions between the electric axle 6, and hence the corresponding electric contact ring 9, and the other two electric axles 5 and 7, and hence the corresponding electric contact rings 8 and 10.

The path of the wire 2 is divided into a pre-heating portion, which is indicated by reference numeral 16 and extends from the electric contact ring 8 to the electric contact ring 9 passing through the transmission rollers 11 and 12, a real annealing portion, which is indicated by reference numeral 17 and goes from the electric contact ring 9 to the electric contact ring 10, and a cooling portion, which is indicated by reference numeral 18 and goes from the electric contact ring 10 to the outlet pull ring 13.

Advantageously, the cooling portion 18 comprises a semicircular path portion 18a around the electrical contact ring 10.

In particular, the annealing furnace 1 comprises a tank 19 full of coolant crossed by the cooling portion 18 to carry out an immersion cooling, and drying devices 20 for drying the wire 2 at the outlet of the tank 19. Alternatively, the tank 19 comprises sprayers (not shown) to spray the coolant on the wire 2.

In the example shown in FIG. 1, the positive potential of the Uann voltage is applied to the electric axle 6 and the negative potential of the Uann voltage is applied to the other two electric axles 5 and 7. This electrical configuration is advantageous with respect to a reversed polarity (positive potential applied to the electric axles 5 and 7 and negative potential applied to the electric axle 6) because it avoids drainage of electric current towards the wire-drawing machine, which is arranged upstream of the annealing furnace 1, and the winding machine, which is arranged downstream of the annealing furnace 1, and reduces the drainage of electric current in the coolant.

Advantageously, the annealing portion 17 passes through an annealing chamber 21. When the annealing furnace 1 is in motion, i.e. when the electric contact rings 8-10 and the outlet pull ring 13 rotate to move the wire 2 forward, the cooling of the wire 2 starting from the semicircular path portion 18a generates steam which prevents the entry of air into the annealing chamber 21, thereby protecting the wire 2 from surface oxidation.

Even more advantageously, the annealing chamber 21 is pneumatically sealed to contain nitrogen, which mixes with the steam coming from the tank 19 so as to provide a protective gaseous mixture that prevents the oxidation of the wire 2. The protective gaseous mixture in the annealing chamber is particularly advantageous where the wire 2 is made of copper or of a copper-based alloy, as copper is quickly oxidized at the annealing temperature, which is higher than 180° C. The oxidation of the surface of the wire would cause an increase in the electrical contact resistance between the wire 2 and the electric contact ring 10 and the formation of sparks.

In the specific example considered, in which the wire is made of aluminium or copper or of an aluminium- or copper-based metal alloy, the pre-heating portion 16 has a length greater than that of the annealing portion 17 so that an Ipht current, which is lower than the Iann current that circulates in the portion of the wire 2 along the annealing portion 17, circulates in the portion of the wire along the pre-heating portion 16, the cross-section of the wire 2 being equal. In this way, the temperature gradient of the wire 2 in the pre-heating portion 16 will be lower than that of the wire 2 in the annealing portion 17.

In accordance with the present invention, one or more of the electric contact rings 8, 9 and 10 is/are made of a non-metal electric conductor material, for example graphite. In this way, there can be no metal migration by diffusion from the wire to the electric contact rings 8, 9 and 10. In particular, each of the electric contact rings 8, 9, 10 comprises a straight circular cylindrical body, which is internally hollow and made of said non-metal electric conductor material.

Advantageously, said graphite of the electric contact rings 8, 9 and 10 is an isotropic graphite.

Advantageously, said graphite has a resistivity value between 1000 and 1300 μΩ·cm, and preferably substantially equal to 1140 μΩ·cm.

Advantageously, said graphite has a coefficient of thermal expansion between 5·10⁻⁶ and 6·10⁻⁶° C.⁻¹, and preferably substantially equal to 5.4·10⁻⁶° C.⁻¹.

Advantageously, said graphite has a thermal conductivity between 100 and 130 W/m° C., and preferably substantially equal to 112 W/m° C.

According to another embodiment shown in FIG. 2, in which the corresponding elements are indicated with the same reference numerals and symbols of FIG. 1, the annealing furnace 1 further comprises an additional protective atmosphere chamber 22, which encloses at least the pre-heating portion 16 and is pneumatically sealed to contain a protective gas, for example nitrogen, in order to avoid or at least reduce the contact of the wire 2 with the air so as to avoid or at least reduce the oxidation of the wire 2. The oxidation of the surface of the wire 2 would cause an increase in the electrical contact resistance between the wire 2 and the electric contact rings 8-10 and the formation of sparks. The oxidation reaction is accelerated by the high temperature of the wire 2, already starting from the pre-heating portion 16.

The protective atmosphere chamber 22 is particularly advantageous where the wire 2 is made of aluminium or of an aluminium-based alloy, as aluminium is easily and quickly oxidized even at room temperature (passivation) and aluminium oxide is a good electrical insulator.

While the above described invention specifically refers to a very precise embodiment, it is not to be considered as limited to this embodiment, all those variants, modifications or simplifications that would be apparent to those skilled in the art falling within its scope, such as for example:
the use of more than two transmission rollers between the first two electric axles 5 and 6; and
the application of the Uann voltage to reversed polarities, i.e. the positive potential applied to the electric axles 5 and 7 and the negative potential to the electric axle 6.

The advantage of the annealing furnace 1 described above is that it can be used for annealing a wire, strand, string, wire rod or strip made of any metal or metal alloy, for example aluminium, aluminium alloy, copper or copper coated with another metal, for example, tin-, nickel- or silver-plated copper, without having to change the electric contact rings on the basis of the particular metal or metal alloy, thanks to the material of which the electric contact rings 8-10 are made.

Obviously, the annealing furnace 1 described above is also suitable for the simultaneous annealing of multiple metal wires or strands or strings or wire rods or strips, after appropriate axial dimensioning of the electric contact rings 8-10, transmission rollers 11 and 12, and outlet pull ring 13, and of their motors.

1. A resistance annealing furnace to anneal at least one metal or metal alloy wire, strand, string, wire rod or strip, the annealing furnace comprising:
at least two electric axles provided with respective electric contact rings for conveying the at least one metal or metal alloy wire, strand, string, wire rod or strip; and
DC voltage generating means, which can be supplied by an AC voltage to generate an annealing voltage applied between the at least two electric axles so as to produce an electric current in a portion of the at least one metal or metal alloy wire, strand, string, wire rod or strip extending between the at least two electric axles, which provokes an annealing due to the Joule effect,
wherein at least one of the electric contact rings is made of a non-metal electric conductor material.

2. The annealing furnace according to claim 1, wherein the non-metal electric conductor material consists of graphite.

3. The annealing furnace according to claim 2, wherein the graphite is isotropic graphite.

4. The annealing furnace according to claim 2, wherein the graphite has a resistivity with a value ranging from 1000 to 1300 μΩ·cm.

5. The annealing furnace according to claim 2, wherein the graphite has a coefficient of thermal expansion ranging from 5·10⁻⁶ to 6·10⁻⁶° C.⁻¹.

6. The annealing furnace according to claim 2, wherein the graphite has a thermal conductivity ranging from 100 to 130 W/m° C.

7. The annealing furnace according to claim 1, wherein the at least two electric axles comprise a first electric axel, a second electric axel, and a third electric axle and the electric contact rings comprise a first electric contact ring, a second electric contact ring and a third electric contact ring defining, in this order, a path for the metal or metal alloy wire, strand, string, wire rod or strip; the annealing voltage being applied with the positive potential to the second electric axle and with the negative potential to the first electric axel and the third electric axle; the path comprising a pre-heating portion, which extends from the first electric contact ring to the second electric contact ring; the annealing furnace comprising a chamber, which encloses at least the pre-heating portion and is pneumatically sealed to contain a protective gas, for instance constituted by nitrogen, with the purpose of avoiding or at least reducing the oxidation of the metal or metal alloy wire, strand, string, wire rod or strip.
